(19) United States
(12) Patent Application Publication
(10) Pub. No.: US 2013/0161845 A1
(43) Pub. Date: Jun. 27, 2013

(54) METHOD OF FORMING AN OPTICAL SURFACE ON A SOLAR COLLECTOR SHELL

(71) Applicant: Robert Romeo, Tucson, AZ (US)

(72) Inventor: Robert Romeo, Tucson, AZ (US)

(21) Appl. No.: 13/706,094

(22) Filed: Dec. 5, 2012

Related U.S. Application Data
(60) Provisional application No. 61/576,171, filed on Dec. 15, 2011.

(51) Int. Cl. H01L 31/042

(52) U.S. Cl. CPC H02S 20/00
USPC 264/1.9

(57) ABSTRACT

A method of forming an optical surface on a solar collector that is made from a composite material adds epoxy to the collector. The epoxy is applied to a mandrel that has an outer surface shaped to conform to a concave side of the collector. The concave side of the collector is laid over the mandrel and into contact with the epoxy. The collector is set on the mandrel by first aligning one of the elongate edges of the collector with an elongate edge of the mandrel. Pivoting the collector about the interface defined between the edges of the collector and mandrel produces a wave front in the epoxy, so that when the collector is laid down onto the mandrel, a substantially uniform layer of epoxy is disposed between the collector and mandrel. Heating the resin bonds it to the collector and forms a substantially smooth optical quality surface.

### BACKGROUND

1. Field of Invention

The invention relates generally to a solar collector. More specifically, the present invention relates to a method of forming a solar collector with a substrate formed from a laminate of plies of a composite.

Solar collection systems that concentrate solar energy generally employ a number of collectors; each having a reflective side configured to focus the reflected light Focusing the reflected light typically entails forming an image that is cast onto a solar conversion cell. Collector configurations must be distinct and carefully shaped to focus the concentrated solar energy onto a solar conversion cell. A misshaped collector usually forms an out of focus Image with a less homogenous flux density than a focused image, thereby reducing system efficiency.

Many obstacles exist when working a material so the reflective, or optical, side of each collector is sufficiently precisely configured to generate a desired image. Manufacturing obstacles are especially prevalent when solar energy collectors are mass produced. For example, while the ram and die of a metal stamping process may be precisely configured to form a collector shell, the stamped shell may not have the desired configuration. Internal stresses in the material being stamped can bend the shell from a desired configuration; where the infernal stresses may be inherent in the material or introduced dining stamping. Also, ram and die sets can wear over time and eventually form collector shells with undesired configurations.

Solar collectors are typically made from a material with some stiffness so the collectors can retain their shape long term and be useable for many years. Moreover, solar collection and conversion systems often consolidate the collectors into a solar array to boost the electricity generating capacity of the conversion system. Thus the material tor the collectors should be strong enough to resist deformation, such as from routine handling or from creep, but also be light enough for handling and mounting.

### SUMMARY OF THE INVENTION

Provided herein is a method of forming an optical surface on a solar collector that is made from a composite material. An epoxy is applied to a mandrel that has an outer surface, shaped to conform to a concave side of the collector. The concave side of the collector is laid over the mandrel and into contact with the epoxy. The collector is set on the mandrel by first aligning one of the elongate edges of the collector with an elongate edge of the mandrel. Pivoting the collector about the interface defined between the edges of die collector and mandrel produces a wave front in the epoxy, so that when the collector is laid down onto the mandrel, a substantially uniform layer of epoxy is disposed between the collector and mandrel. Heating the resin bonds it to the collector and forms a substantially smooth optical quality surface.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side view of m example of epoxy being applied to a mandrel and a perspective view of an example of a solar collector shell in accordance with the present invention.

FIG. 2 is a perspective view of a step of setting the shell of FIG. 1 onto the mandrel of FIG. 1 in accordance with the present invention.

FIG. 3 is an end view of the example step of FIG. 2 in accordance with the present invention.

FIG. 4 is an end view of the shell and mandrel of FIG. 2 being heated in accordance with the present invention.

FIG. 5 is an end view of an example of the shell and mandrel of FIG. 4 after being heated.

FIG. 6 is a side perspective view of an example of separating the shell and mandrel of FIG. 5 in accordance with the present invention.

FIG. 7 is a side perspective view of a shell for a solar collector having an optical surface in accordance with the present invention.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now he described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

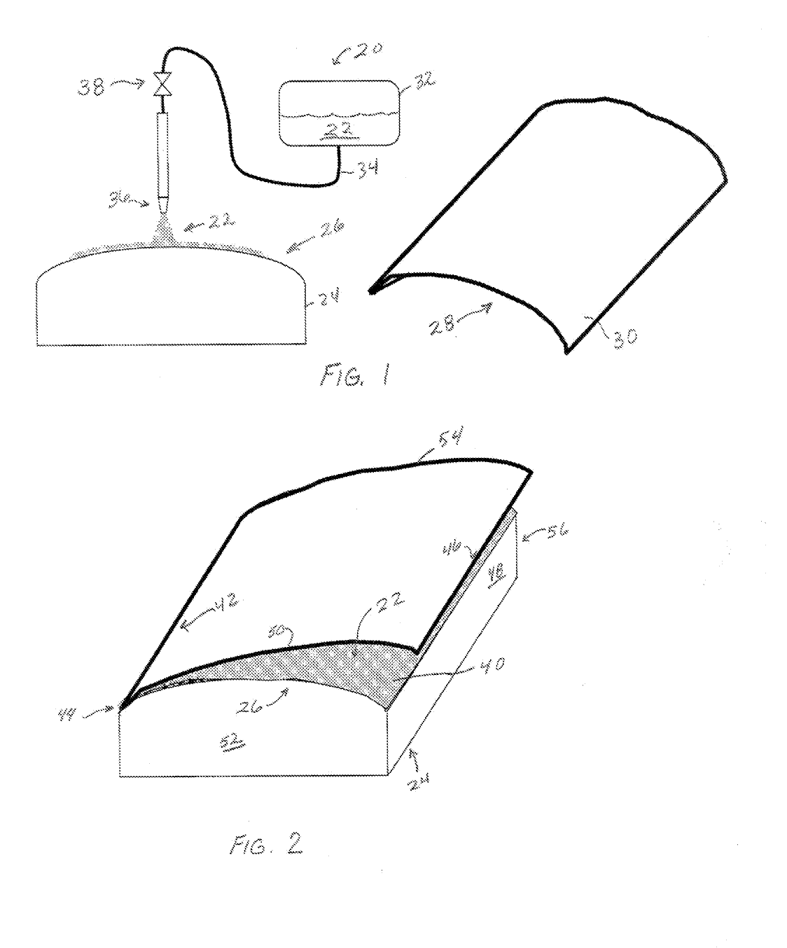

An epoxy delivery system 20 is shown in a side schematic view in FIG. 1 and shown being used to apply epoxy 22 onto a mandrel 24. In the example of FIG. 1, the mandrel 24, which is shown in an end view, is a substantially solid member that in one example is made of stainless steel, and as an upper surface 26 that is contoured in a convex-like configuration. The upper surface 26 corresponds in shape to a concave side 28 of a solar collector shell 30 shown in perspective view in FIG. 1. The epoxy delivery system 20 is shown including a reservoir 32 in which an amount of epoxy 22 is stored. A line 34 is shown attached to the reservoir 32 on one end and a nozzle 36 on the other for delivering epoxy 22 to the nozzle 36 for application onto the upper surface 26. An optional valve 38 is shown in the line 34 for controlling the flow of epoxy 22 through the line 34.

In one example of the method described herein, epoxy 22 is applied to substantially the entire area of the upper surface and as illustrated in the side perspective view in FIG. 2, the epoxy 22 forms a layer on the upper surface 26. Also illustrated in FIG. 2 is that the elongate lateral edge 42 of the shell 30 is set on an elongate lateral side 44 of the mandrel 24. Further illustrated is that an elongate lateral edge 46 on a side of the shell 30 opposite elongate lateral edge 42 is raised up and away from lateral side 48 of the mandrel 24. A forward edge 50 is defined on the shell 30 on the periphery between the lateral edges 42, 46. Similarly, a forward side 52 is defined on the end of the mandrel 24 on an end between the lateral sides 44, 48. A rearward edge 54 extends along the periphery of the shell 30 between the lateral edges 42,46 and on an end opposite the forward edge. A rearward side 56 is on an end of the mandrel 24 opposite the forward side 52.

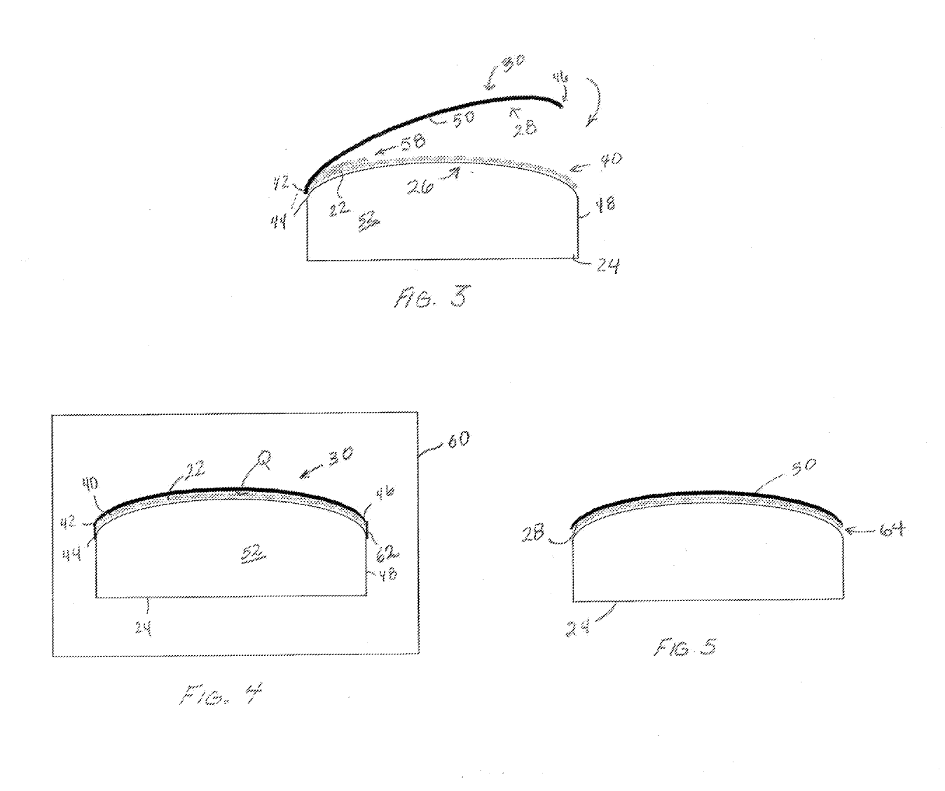

Referring now to FIG. 3, example is shown of the shell 30 being pivoted about the interface defined between the lateral edge 42 and lateral side 44. As pivoting the shell 30, in the direction in the arrow A, brings the concave surface of the shell 30 into contact with the layer 40 on the tipper surface 26. Further, in the example of FIG. 3, the active pivoting the shell 30 is controlled so that a wave front 50 is formed in the layer 40 thereby ensuring epoxy 22 is present between the shell 30 and mandrel 24 when the shell 30 is positioned on top of the mandrel 24. It is believed it is within the capabilities of those skilled in the art to land the shell 30 on the mandrel 24 in a way to form the appropriate wave front in the layer 40.

Referring to FIG. 4, the combination of mandrel 24, shell 30 and layer 40 is shown set within an enclosure 60 so that heat Q may be applied to the layer 40 for curing the epoxy in the layer 40. Optionally, a layer of tape 62 may be provided over the periphery of the layer 40 and extending from the respective peripheries of the shell 30 and mandrel 24. Application of the tape 62 can retain epoxy 22 between the shell 30 and mandrel and prevent epoxy 22 from flowing from between the shell 30 and mandrel and onto lateral sides of the mandrel 24.

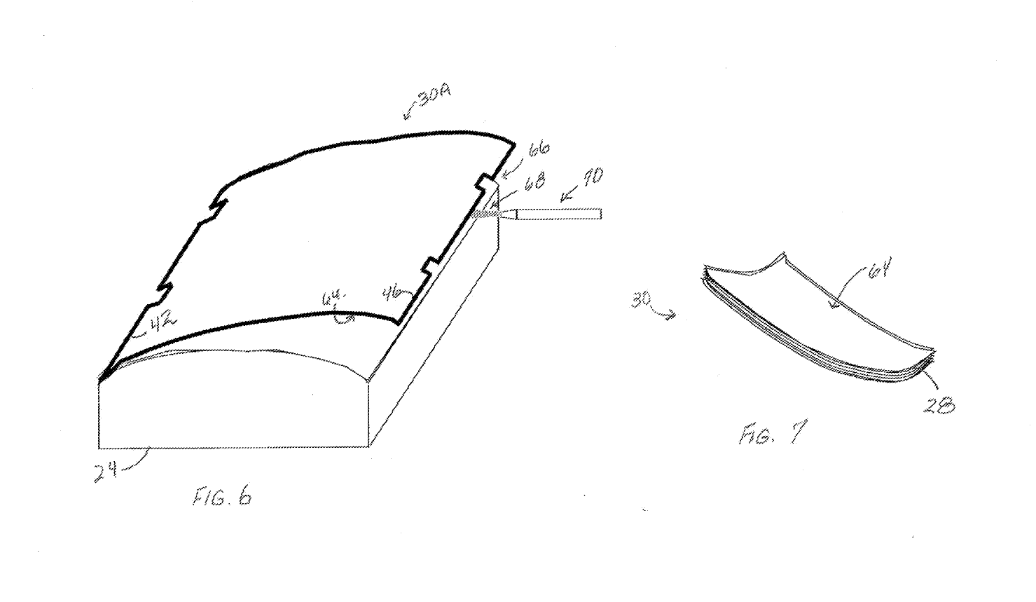

An end view in FIG. 5, the mandrel 24 and shell is shown having been removed from the enclosure 60 and after the resin 22 has cured thereby forming a reflective surface 64 on the concave surface 28 of the shell 30. In one example, the step of heating within the enclosure 60 includes maintaining a temperature of about 85° C. at one atmosphere, for about 50 minutes so that the epoxy can reach a gel stage and produce transformation of the epoxy into the reflective surface 64. FIG. 6 illustrates a step of removing a shell 30A from mandrel 24. In this example, the shell 30A includes tabs 66 that have been recessed inward along the lateral edges 42, 46 of the shell 30A. In one example, the tabs 66 are used for alignment purposes after the shell 30A has been finally configured for use as a solar collector and is being disposed within an array (not shown) of solar collectors. In the example, when the shell 30A includes tabs 66, a room temperature vulcanization (RTV) may be applied along the peripheral interface between the shell 30A and mandrel 24 in lieu of the tape 62. Use of the RTV eases time and step of cleaning away the barrier material after the step of curing the epoxy. Optionally, a stream 68 of pressurized gas, such as air, may be directed in the space between the shell 30A and mandrel 24 to coax the shell 30 from the mandrel. An advantage of a stream of compressed gas is that it avoids contacting the shell 30A with objects, such as a pry bar, that may mar or otherwise damage the reflective surface 64 thereby affecting the reflective qualities of the finished solar collector. A gas line 70 is shown as the source of the stream 68 and cart be connected to a compressor or other source of compressed gas.

Illustrated in perspective view in FIG. 7 is an example of a shell 30 having the optical surface 64 formed on the concave surface 28. As is known, a reflective material may be applied onto the optical surface 64 thereby forming a reflective solar collector from the shell 30 of FIG. 7. The solar collector can then be used for collecting solar energy onto a solar cell for generating electricity.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A method of forming an optical surface comprising:
applying a thermosetting resin to a convex shaped surface of a mandrel;
providing a solar collector shell having a concave shaped surface that conforms to the convex shaped surface of the mandrel;
placing the solar collector shell onto the mandrel so that the concave shaped surface is positioned on the convex shaped surface and the resin is disposed between the solar collector shell and the mandrel; and
using heat to cure the resin thereby forming an optical surface on the concave shaped surface of the solar collector shell.

2. The method of claim 1, wherein the step of placing the solar collector shell onto the mandrel comprises aligning respective lateral edges of the shell and mandrel, putting the edges into contact to define an axis, and pivoting the shell about the axis so the concave shaped surface of the shell is directed towards the convex shaped surface of the mandrel.

3. The method of claim 2, wherein a wavefront is formed in the epoxy between the shell and mandrel during the step of pivoting.
